(19) United States
(12) Patent Application Publication
(10) Pub. No.: US 2026/0244865 A1
(43) Pub. Date: Aug. 20, 2026

(54) ELECTRONIC DEVICE FOR PERFORMING CALCULATION USING ARTIFICIAL INTELLIGENCE MODEL, AND METHOD FOR OPERATING ELECTRONIC DEVICE

(71) Applicant: SAMSUNG ELECTRONICS CO., LTD., Suwon-si (KR)

(72) Inventors: Jungbae KIM, Suwon-si (KR); Euntaik LEE, Suwon-si (KR); Dohyoung KIM, Suwon-si (KR); Mooyoung KIM, Suwon-si (KR); Hyeonsu LEE, Suwon-si (KR); Gyusung CHO, Suwon-si (KR)

(21) Appl. No.: 19/641,984

(22) Filed: Apr. 8, 2026

Related U.S. Application Data
(63) Continuation of application No. PCT/KR2024/016440, filed on Oct. 25, 2024.

(30) Foreign Application Priority Data
Nov. 2, 2023 (KR) 10-2023-0150207
Jan. 2, 2024 (KR) 10-2024-0000286

(51) Int. Cl. G06F 40/284; G06F 40/232; G06F 40/58; G06N 3/045

(52) U.S. Cl. CPC G06F 40/284; G06F 40/232; G06F 40/58; G06N 3/045

(57) ABSTRACT

An electronic device may include a memory for storing a first artificial intelligence model, and a processor. The first artificial intelligence model may include: a prompt execution unit for executing a user prompt; and a token generation unit for generating a single token. The processor(s) may: measure at least one of the accuracy, a memory usage, or an operation speed of the first artificial intelligence model on the basis of the execution of instructions stored in the memory and stores the measured result in the memory; determine the type of first data to be provided to the prompt execution unit among the plurality of data types; determine the type of second data to be provided to the token generation unit; generates a second artificial intelligence model on the basis of the type of the first data and the type of the second data; and determine whether to use the second artificial intelligence model by comparing at least one of the accuracy, a memory usage, or an operation speed of the second artificial intelligence model with that of the first artificial intelligence model.

### CROSS-REFERENCE TO RELATED APPLICATIONS

This application is a continuation application of International Application No. PCT/KR2024/016440 designating the United States, filed on Sep. 3, 2024, in the Korean Intellectual Property Receiving Office and claiming priority to Korean Patent Application No. 10-2023-0150207, filed on Nov. 2, 2023, and Korean Patent Application No. 10-2024-0000286, filed on Jan. 2, 2024, the disclosures of which are all hereby incorporated by reference herein in their entireties.

### Technical Field

Certain example embodiments may relate to an electronic device and, for example, to an electronic device for performing computation using an artificial intelligence model, and/or a method of operating the electronic device.

### Background

Recently, with the development of artificial intelligence (AI) technologies and the improvement of mobile terminal calculation capabilities, AI technologies have been used in various fields of mobile terminals. Smartphones, wearable devices, TVs, smart home appliances, AI speakers, and many other devices may include trained models for performing various functions such as device operations, measurements, result predictions, content recommendations, and decision-making. Such models may be equipped and used in the initial stage of device production, or performance of the models may be continuously improved through an updates from a server.

The information may be provided as the related art to help understanding of the disclosure. None of the above-described information is to be considered as prior art with respect to the disclosure, nor may it be used to determine prior art.

### SUMMARY

When the type of the artificial intelligence model is FP32, the prompt executor and the token generator may also use a single data type. The prompt executor may use the data type of FP32, and the token generator may also use the data type of FP32.

However, according to an actual embodiment, even if the prompt executor and the token generator are determined to be different data types, the original artificial intelligence model and the operation performance scheme may be the same. When the prompt executor and the token generator are determined to be different data types from the original artificial intelligence model, there may be a difference in terms of data processing accuracy, but this may vary according to the type of a task (e.g., translation, response, spelling correction, or summary) being processed.

When the prompt executor and the token generator use different data types compared to the case in which they use the data type of FP32 in a batch, there is a disadvantage in that the accuracy of inference may be reduced. However, the required accuracy of inference may differ according to the type of a task (e.g., translation, reply, typo correction, and summarization). In other words, since the inference accuracy or performance required for each task type is different, a situation may occur where the prompt executor and the token generator can perform sufficient learning even if they have different data types.

According to an example embodiment, a model used in the AI field may be trained using an architecture (state-of-the-art) as a basic design, or may be configured to have a unique data type (FP32, FP16, INT8, or INT4) according to a purpose. In addition, the actual AI model inference process will also be performed using the data type used in the actual model training step.

In AI model fields, a large language model (LLM) has a huge model size, and various methods for reducing the size are currently being performed. For example, active research on language models such as the LLM is being conducted to reduce the actual model size through 4-bit quantization, and a 4-bit quantization degree of an LLM small model may reach a level that can be mounted on a handset device.

The 4-bit quantization has ¼ the number of physical bits compared to FP32, and therefore, the model size is reduced, but the probability of drop (or omission) in accuracy is inevitably increased. In this document, a scheme for obtaining results substantially the same as those of the original (FP32) model, compared to the case of using a single 4-bit quantization model, is proposed by changing the model configuration according to a data type.

An example electronic device may include a memory configured to store a first artificial intelligence model and a processor (including one or more processors) comprising processing circuitry, wherein the first artificial intelligence model may include a prompt executor configured to execute a user prompt, and a token generator configured to generate a single token, and wherein the processor (including one or more processors) may be individually and/or collectively configured to, based on that instructions stored in the memory are executed, measure and store, in the memory, at least one of accuracy, memory usage, or computational speed of the first artificial intelligence model, determine a type of first data to be provided to the prompt executor among a plurality of data types, determine a type of second data to be provided to the token generator, generate a second artificial intelligence model, based on the type of the first data and the type of the second data, and determine whether to use the second artificial intelligence model by comparing at least one of accuracy, memory usage, or computational speed of the second artificial intelligence model with the first artificial intelligence model.

An example operation method may include measuring and storing, in a memory, at least one of accuracy, memory usage, or computational speed of a first artificial intelligence model, determining a type of first data to be provided to a prompt executor among a plurality of data types, determining a type of second data to be provided to a token generator, generating a second artificial intelligence model, based on the type of the first data and the type of the second data, and determining whether to use the second artificial intelligence model by comparing at least one of accuracy, memory usage, or computational speed of the generated second artificial intelligence model with the first artificial intelligence model.

An example recording medium may include a memory configured to store a first artificial intelligence model and a processor, and the first artificial intelligence model may include a prompt executor configured to execute a user prompt and a token generator configured to generate a single token The memory may be configured to store instructions, when executed, causing the processor to measure and store, in the memory, at least one of accuracy, memory usage, or computational speed of the first artificial intelligence model, determine a type of first data to be provided to the prompt executor among a plurality of data types, determine a type of second data to be provided to the token generator, generate a second artificial intelligence model, based on the type of the first data and the type of the second data, and determine whether to use the second artificial intelligence model by comparing at least one of accuracy, memory usage, or computational speed of the second artificial intelligence model with the first artificial intelligence model.

When the prompt executor and the token generator use different data types compared to the case in which they use the data type of FP32 in a batch, it is possible to save the memory capacity, reduce the inference time, relatively reduce the power consumption, and reduce the CPU usage. Therefore, an example electronic device may determine the accuracy required for each type of the task and determine a first data type of the prompt executor and a second data type of the token generator to be different, thereby reducing the memory usage, reducing power consumption, and improving computational speed while performing tasks without errors.

### BRIEF DESCRIPTION OF DRAWINGS

FIG. 1 is a block diagram of an electronic device in a network environment according to various example embodiments.

FIG. 2 is a block diagram illustrating an integrated intelligence system according to an example embodiment.

FIG. 3 is a block diagram illustrating configurations of an electronic device and a server according to various example embodiments.

FIG. 4 is a block diagram illustrating a learning model management system according to various example embodiments.

FIG. 5A illustrates a token generation method in an artificial intelligence model according to a comparative embodiment.

FIG. 5B illustrates a configuration of an artificial intelligence model according to a comparative embodiment.

FIG. 5C is a diagram illustrating example static allocation.

FIG. 5D is a diagram illustrating example dynamic allocation.

FIGS. 5E and 5F illustrate a model generated as a single data type according to a comparative embodiment.

FIG. 6 is a block diagram illustrating a method by which an electronic device configures an artificial intelligence model according to various example embodiments.

FIGS. 7A and 7B illustrate a process of distinguishing models satisfying performance among combinations of a plurality of artificial intelligence models according to various example embodiments.

FIGS. 8A and 8B illustrate embodiments in which an electronic device configures different artificial intelligence models according to performance for the same task according to various example embodiments.

FIG. 9 is a flowchart illustrating a method by which an electronic device configures an artificial intelligence model according to various example embodiments.

FIG. 10 is a flowchart illustrating a method by which an electronic device configures an artificial intelligence model according to various example embodiments.

### DETAILED DESCRIPTION

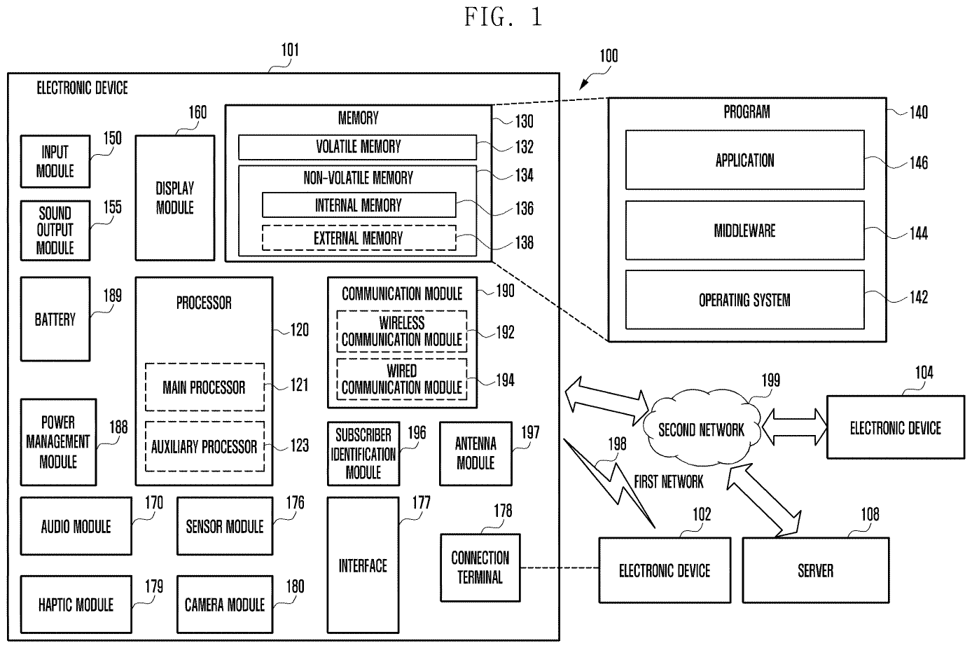

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via at least a third element(s).

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

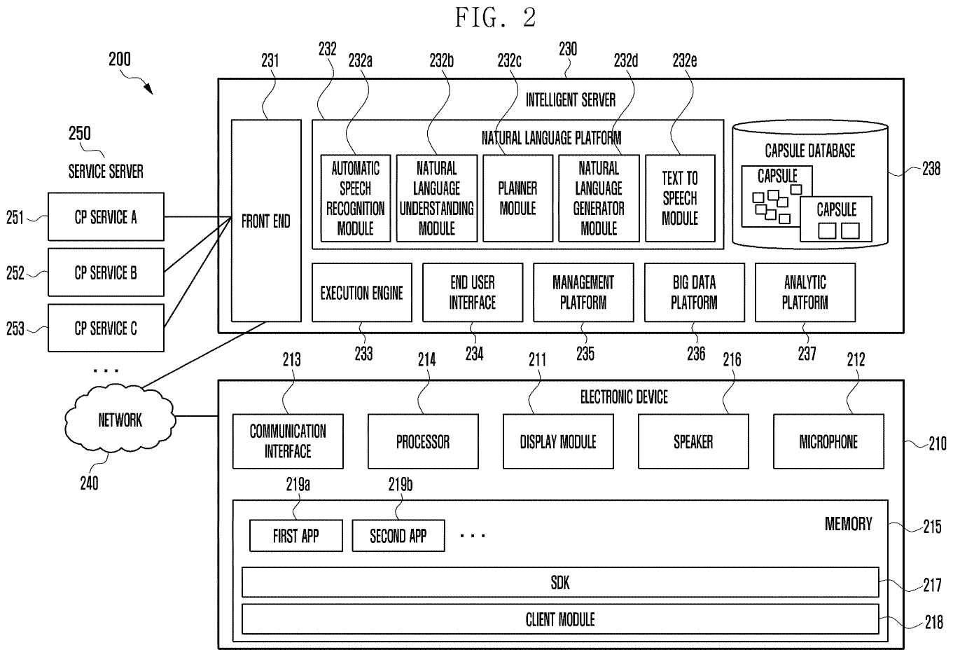

FIG. 2 is a block diagram illustrating an integrated intelligence system according to various embodiments.

Referring to FIG. 2, according to an embodiment, the unified intelligence system may include an electronic device 210 (e.g., the electronic device 101 of FIG. 1), an intelligent server 230 (e.g., the server 108 of FIG. 1), and a service server 250 (e.g., the server 108 of FIG. 1).

According to an embodiment, the electronic device 210 may be a terminal device (or an electronic device) capable of being connected to the Internet, and may be, for example, a mobile phone, a smartphone, a personal digital assistant (PDA), a notebook computer, a TV, white goods, a wearable device, an HMD, or a smart speaker.

According to the illustrated embodiment, the electronic device 210 may include a communication interface 213 (e.g., the interface 177 of FIG. 1), a microphone 212 (e.g., the input module 150 of FIG. 1), a speaker 216 (e.g., the sound output module 155 of FIG. 1), a display module 211 (e.g., the display module 160 of FIG. 1), a memory 215 (e.g., the memory 130 of FIG. 1), or a processor 214 (e.g., the processor 120 of FIG. 1). The listed components may be operatively or electrically connected, directly or indirectly, to each other. The electronic device 210 may include at least some of the configurations and/or functions of the electronic device 101 of FIG. 1.

According to an embodiment, the communication interface 213 may be connected, directly or indirectly, to an external device and configured to transmit/receive data. According to an embodiment, the microphone 212 may receive a sound (e.g., a user utterance) and convert the same into an electric signal. According to an embodiment, the speaker 216 may output an electric signal as a sound (e.g., a voice).

According to an embodiment, the display module 211 may be configured to display an image or a video. According to an embodiment, the display module 211 may also display a graphic user interface (GUI) of an executed application program. The display module 211 of an embodiment may receive a touch input through a touch sensor. For example, the display module 211 may receive a text input through the touch sensor in an image keyboard area displayed within the display module 211.

According to an embodiment, the memory 215 may store a client module 218, a software development kit (SDK) 217, and a plurality of apps 219a and 219b. The client module 218 and the SDK 217 may configure a framework (or a solution program) for performing a universal function. In addition, the client module 218 or the SDK 217 may configure a framework for processing user inputs (e.g., a voice input, a text input, and a touch input).

According to an embodiment, the plurality of apps 219a and 219b stored in the memory 215 may be programs for performing predetermined functions. According to an embodiment, the plurality of apps may include a first app 219a and a second app 219b. According to an embodiment, each of the plurality of apps 219a and 219b may include a plurality of operations to perform predetermined functions. For example, the apps 219a and 219b may include an alarm app, a message app, and/or a schedule app. According to an embodiment, the plurality of apps 219a and 219b may be executed by the processor 214 to sequentially perform at least some of the plurality of operations.

According to an embodiment, the processor 214 may control the overall operation of the electronic device 210. For example, the processor 214 may be electrically connected to the communication interface 213, the microphone 212, the speaker 216, and the display module 211 to perform predetermined operations.

According to an embodiment, the processor 214 may also perform a predetermined function by executing a program stored in the memory 215. For example, the processor 214 may execute at least one of the client module 218 or the SDK 217 to perform the following operations for processing a user input. The processor 214 may, for example, control the operations of the plurality of apps 219a and 219b through the SDK 217. The following operations described as the operations of the client module 218 or the SDK 217 may be operations performed by the execution of the processor 214.

According to an embodiment, the client module 218 may receive a user input. For example, the client module 218 may receive a voice signal corresponding to a user utterance detected through the microphone 212. Alternatively, the client module 218 may receive a touch input detected through the display module 211. Alternatively, the client module 218 may receive a text input detected through a keyboard or an image keyboard. In addition to the above, the electronic device 210 may receive various types of user inputs detected through an input module included in the electronic device 210 or an input module connected to the electronic device 210. The client module 218 may transmit the received user input to the intelligent server 230. The client module 218 may transmit the received user input along with state information of the electronic device 210 to the intelligent server 230. The state information may be, for example, application execution state information.

According to an embodiment, the client module 218 may receive a result corresponding to the received user input. For example, when the client module 218 is capable of calculating the result corresponding to the received user input from the intelligent server 230, the client module 218 may receive the result corresponding to the received user input. The client module 218 may display the received result on the display module 211. In addition, the client module 218 may output the received result as audio through the speaker 216.

According to an embodiment, the client module 218 may receive a plan corresponding to the received user input. The client module 218 may display a result of executing a plurality of operations of the app according to the plan on the display module 211. The client module 218 may sequentially display, for example, results of the plurality of operations on the display module 211 and output audio through the speaker 216. The electronic device 210 may display, for example, only some of the results of the plurality of operations executed (e.g., the result of the last operation) on the display module 211, and may output the same as audio through the speaker 216.

According to an embodiment, the client module 218 may receive a request for acquiring information required to calculate a result corresponding to a voice input from the intelligent server 230. According to an embodiment, the client module 218 may transmit the required information to the intelligent server 230 in response to the request.

According to an embodiment, the client module 218 may transmit result information obtained by executing the plurality of operations according to the plan to the intelligent server 230. The intelligent server 230 may identify that the received user input has been properly processed using the result information.

According to an embodiment, the client module 218 may include a voice recognition module. According to an embodiment, the client module 218 may recognize a voice input for performing a limited function through the voice recognition module. For example, the client module 218 may perform an intelligent app for processing a voice input for performing an organic operation through a predetermined input (e.g., “wake up!”).

According to an embodiment, the intelligent server 230 may receive information related to a user voice input from the electronic device 210 through a communication network. According to an embodiment, the intelligent server 230 may change data related to the received voice input into text data. According to an embodiment, the intelligent server 230 may generate a plan for performing a task corresponding to the user voice input, based on the text data.

According to an embodiment, the plan may be generated by an artificial intelligence (AI) system. The artificial intelligence system may be a rule-based system, a neural network-based system (e.g., a feedforward neural network (FNN)), or a recurrent neural network (RNN)). Alternatively, the artificial intelligence system may be a combination of the above or an artificial intelligence system different from the above. According to an embodiment, the plan may be selected from a set of pre-defined plans or generated in real time in response to a user request. For example, the artificial intelligence system may select at least one of the plurality of pre-defined plans.

According to an embodiment, the intelligent server 230 may transmit a result according to the generated plan to the electronic device 210, or may transmit the generated plan to the electronic device 210. According to an embodiment, the electronic device 210 may display the result according to the plan on the display module 211. According to an embodiment, the electronic device 210 may display a result of performing the operation according to the plan on the display module 211.

According to an embodiment, the intelligent server 230 may include a front end 231, a natural language platform 232, a capsule database (DB) 238, an execution engine 233, an end user interface 234, a management platform 235, a big data platform 236, or an analytic platform 237.

According to an embodiment, the front end 231 may receive a user input received from the electronic device 210. The front end 231 may transmit a response corresponding to the user input.

According to an embodiment, the natural language platform 232 may include an automatic speech recognition module (ASR module) 232a, a natural language understanding module (NLU module) 232b, a planner module 232c, a natural language generator module (NLG module) 232d, or a text to speech module (TTS module) 232e.

According to an embodiment, the automatic speech recognition module 232a may convert a voice input received from the electronic device 210 into text data. According to an embodiment, the natural language understanding module 232b may identify a user's intent by using the text data of the voice input. For example, the natural language understanding module 232b may detect a user's intent by performing syntactic analysis or semantic analysis on a user input in the form of text data. According to an embodiment, the natural understanding module 232 may detect a meaning of a word extracted from the voice input by using a linguistic characteristic (for example, a grammatical element) of a morpheme or a phrase and match the detected meaning of the word with the intent, so as to determine the user's intent. The natural language understanding module 223b may acquire intent information corresponding to a user utterance. The intent information may be information indicating the user's intent determined by interpreting text data. The intent information may include information indicating an operation or function to be executed by using the device.

According to an embodiment, the planner module 232c may generate a plan by using the intent and the parameter determined by the natural language understanding module 232b. According to an embodiment, the planner module 232c may determine a plurality of domains necessary to perform a task, based on the determined intent. The planner module 232c may determine a plurality of operations included in a plurality of respective domains determined based on the intent. According to an embodiment, the planner module 232c may determine a parameter necessary for executing the plurality of determined operations, or a result value output by the execution of the plurality of operations. The parameter and the result value may be a concept of a specified format (or class). Accordingly, the plan may include a plurality of operations and a plurality of concepts determined by the user's intention. The planner module 232c may determine the plurality of operations and the relationship between the plurality of concepts step-by-step (or hierarchically). For example, the planner module 232c may determine an execution order of the plurality of operations determined based on the user's intent, based on the plurality of concepts. In other words, the planner module 232c may determine the execution order of the plurality of operations, based on the parameters necessary for executing the plurality of operations and the results output by execution of the plurality of operations. Accordingly, the planner module 232 may generate a plan including information on the relationship (e.g., ontology) between the plurality of operations and the plurality of concepts. The planner module 232c may generate a plan by using information stored in the capsule database that stores a set of relationships between concepts and operations.

According to an embodiment, the natural language generation module 232d may change predetermined information into a text form. The information changed in the text form may have a natural language utterance form. According to an embodiment, the text to speech module 232e may change the information in the text form to the information in the voice form.

According to an embodiment, a part or all of the functions of the natural language platform 232 may also be implemented in the electronic device 210.

The capsule database may store information on the relationship between a plurality of concepts and operations corresponding to a plurality of domains. The capsule according to an embodiment may include a plurality of operation objects (action objects or action information) and concept objects (or concept information) included in the plan. According to an embodiment, the capsule database may store a plurality of capsules in the form of a concept action network (CAN). According to an embodiment, the plurality of capsules may be stored in a function registry included in the capsule database.

The capsule database may include a strategy registry storing strategy information required when a plan corresponding to a user input is determined. The strategy information may include reference information for determining one plan when there are a plurality of plans corresponding to a user input. According to an embodiment, the capsule database may include a follow up registry storing the following operation to suggest the following operation to the user in a predetermined situation. The follow up operation may include, for example, a follow up utterance. According to an embodiment, the capsule database may include a layout registry storing layout information of the information output through the electronic device 210. According to an embodiment, the capsule database may include a vocabulary registry storing vocabulary information included in the capsule information. According to an embodiment, the capsule database may include a dialogue registry storing information on dialogue (or interaction) with the user. The capsule database may update the stored object through a developer tool. The developer tool may include, for example, a function editor for updating the operation object or the concept object. The developer tool may include a vocabulary editor for updating a vocabulary. The developer tool may include a strategy editor for generating and registering a strategy to determine a plan. The developer tool may include a dialogue editor for generating a dialogue with the user. The developer tool may include a follow up editor for activating a follow up goal and editing a follow up utterance that provides a hint. The follow up goal may be determined based on a currently configured target, a user's preference, or environmental conditions. In an embodiment, the capsule database may also be implemented in the electronic device 210.

According to an embodiment, the execution engine 233 may calculate a result by using the generated plan. The end-user interface 234 may transmit the calculated result to the electronic device 210. Accordingly, the electronic device 210 may receive the result and provide the received result to the user. According to an embodiment, the management platform 235 may manage information used by the intelligent server 230. According to an embodiment, the big data platform 236 may collect the user's data. According to an embodiment, the analytic platform 237 may manage the quality of service (QoS) of the intelligent server 230. For example, the analytic platform 237 may manage the components and processing speed (or efficiency) of the intelligent server 230.

According to an embodiment, the service server 250 may provide a predetermined service (e.g., food ordering or hotel reservation) to the electronic device 210. According to an embodiment, the service server 250 may be a server operated by a third party. According to an embodiment, the service server 250 may provide information for generating a plan corresponding to the received voice input to the intelligent server 230. The provided information may be stored in the capsule database. In addition, the service server 250 may provide result information according to the plan to the intelligent server 230. The service server 250 may include a plurality of service providers (e.g., CP service A 251, CP service B 252, and CP service C 253), and each of the service providers 251, 252, and 253 may provide a function for the domain related to each capsule stored in the capsule database 238 of the intelligent server 230.

In the unified intelligence system described above, the electronic device 210 may provide various intelligent services to the user in response to a user input. The user input may include, for example, an input through a physical button, a touch input, or a voice input.

According to an embodiment, the electronic device 210 may provide a voice recognition service through an intelligent app (or a voice recognition app) stored internally. In this case, for example, the electronic device 210 may recognize a user utterance or a voice input received through the microphone 212 and provide a service corresponding to the recognized voice input to the user.

According to an embodiment, the electronic device 210 may perform a predetermined operation, alone or in conjunction with the intelligent server 230 and/or the service server 250, based on the received voice input. For example, the electronic device 210 may execute an app corresponding to the received voice input and perform a predetermined operation through the executed app.

According to an embodiment, when the electronic device 210 provides a service in conjunction with the intelligent server 230 and/or the service server 250, the electronic device 210 may detect a user utterance using the microphone 212 and generate a signal (or voice data) corresponding to the detected user utterance. The electronic device 210 may transmit the voice data to the intelligent server 230 through the network 240 by using the communication interface 213.

According to an embodiment, the intelligent server 230 may generate a plan for performing a task corresponding to the voice input or a result of performing an operation according to the plan, as a response to the voice input received from the electronic device 210. The plan may include, for example, a plurality of operations for performing a task corresponding to the user's voice input and a plurality of concepts related to the plurality of operations. The concept may be definition of a parameter input to the execution of the plurality of operations or a result value output by the execution of the plurality of operations. The plan may include information between a plurality of operations and a plurality of concepts.

According to an embodiment, the electronic device 210 may receive the response by using the communication interface 213. The electronic device 210 may output a voice signal generated inside the electronic device 210 to the outside by using the speaker 216, or may output an image generated inside the electronic device 210 to the outside by using the display module 211.

Although FIG. 2 illustrates an example in which voice recognition of the user input received by the electronic device 210, natural language understanding and generation, and a result calculation operation using a plan are performed on the intelligent server 230, the various embodiments of the disclosure are not limited thereto. For example, at least some components (e.g., the natural language platform 232, the execution engine 233, and the capsule database 238) of the intelligent server 230 may be embedded in the electronic device 210 (or the electronic device 101 in FIG. 1), and operations thereof may be performed by the electronic device 210.

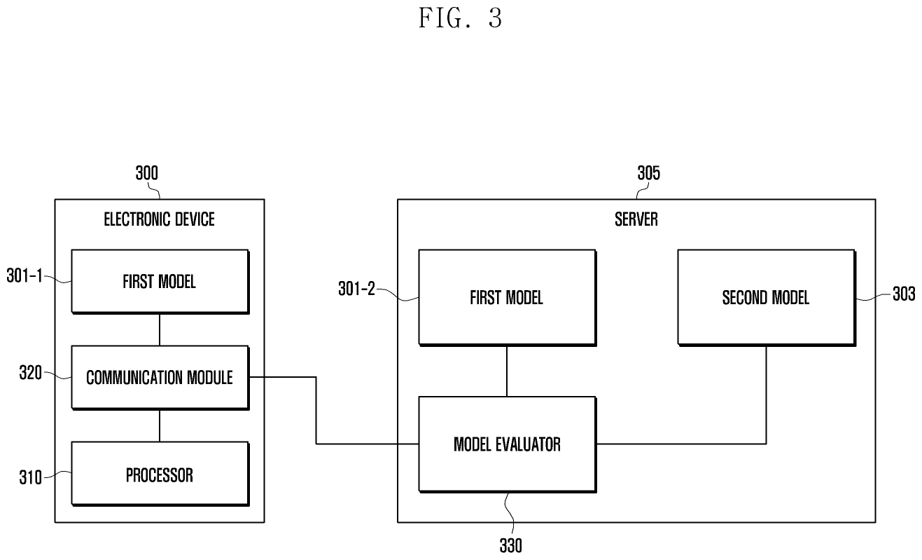

FIG. 3 is a block diagram illustrating configurations of an electronic device and a server according to various embodiments.

According to various embodiments, the electronic device 300 may include a processor 310, a communication module 320, and a first model 301-1, and some of the illustrated configurations may be omitted or replaced. The electronic device may further include at least some of the configurations and/or functions of the electronic device 101 in FIG. 1. At least some of the configurations of the electronic device which are (or are not) illustrated may be operatively, functionally, and/or electrically connected to each other.

According to various embodiments, the processor 310 may be configured by one or more processors as configurations capable of performing operations or data processing regarding control and/or communication of the respective components of the electronic device. The processor 310 may include at least some of the configurations and/or functions of the processor 120 in FIG. 1.

According to various embodiments, there is no limit to operations and data processing functions that can be implemented by the processor 310 in the electronic device 300, but a feature associated with the control of a trained model will be described below in detail. The operations of the processor 310 may be performed by loading instructions stored in the memory.

According to various embodiments, the communication module 320 may communicate with an external device through a wireless network according to the control of the processor 310. The communication module 320 may include hardware and software modules for transmitting and receiving data from a cellular network (e.g., long term evolution (LTE) network, 5G network, and new radio (NR) network) and a short-range network (e.g., Wi-Fi and Bluetooth). The communication module 320 may include at least some of the configurations and/or functions of the communication module 190 in FIG. 1.

The electronic device 300 according to an embodiment may be implemented in various forms. For example, the electronic device 300 described in the specification may include a smart TV, a set-top box, a mobile phone, a tablet PC, a digital camera, a laptop computer, a desktop, an e-book terminal, a digital broadcast terminal, a personal digital assistant (PDA), a portable multimedia player (PMP), a navigation, an MP3 player, a wearable device, and the like, but is not limited thereto.

According to an embodiment, the input information may refer to information input to the first model 301-1 in order to perform an operation. In addition, the output information may refer to a result of processing the input information on the first model 301-1. The server may obtain output information of the first model 301-1. The server may perform various operations, based on the output information of the first model 301-1. For example, the server may determine that the performance of the existing trained model installed in the terminal has been degraded, based on the output information of the first model 301-1. The server may learn a new trained model, based on that the performance of the existing trained model has been degraded, and distribute the same to the UE.

The first model 301-1 according to an embodiment may be one of at least one artificial intelligence model for performing various operations in the electronic device 300. For example, the first model 301-1 may be an artificial intelligence model for various operations which may be performed in the electronic device 300, such as a voice recognition model, a natural language processing model, an image recognition model, and the like. The first model 301-1 is not limited to the above examples and may be one of various types of AI models.

According to an embodiment, the server 305 may use the second model 303 which has a higher performance than the first model 301-2 to transmit information related to the update of the first model 301-1 to the communication module 320 of the electronic device 300. The electronic device 300 may update the trained model by using the information related to the update of the first model 301-1. According to an embodiment, the electronic device 300 may continuously update the trained model, based on information provided from the server 305. The electronic device 300 may output the output information corresponding to input information by using the updated trained model (e.g., the second model 303).

According to an embodiment, the subject learning a new trained model and the subject distributing the new trained model may be the same or different. For example, the server 305 may learn a new trained model, and may transmit or distribute the new trained model to the electronic device 300, based on that a signal making a request for the new trained model is received from the electronic device 300. Alternatively, the server 305 may learn the new trained model, and transmit the new trained model to another server (not shown). The other server (not shown) having received the new trained model may transmit or distribute the new trained model to the electronic device 300, based on a request from the electronic device 300.

According to an embodiment, the second model 303 has a relatively larger size than the first model 301-2, and thus the probability that appropriate output information for the user is output may be relatively higher. The second model 303 according to an embodiment may be an artificial intelligence model including more nodes and neural network layers than the first model 301-2, since the second model 303 may be processed by the server 305 having relatively high performance.

According to an embodiment, the electronic device 300 may receive information indicating an improvement of the new trained model from a model evaluator 330 of the server 305, using the communication module 302. The electronic device 300 may determine the necessity of the new trained model, based on the information indicating the improvement of the new trained model. In response to determination that an update to a new model is necessary, the electronic device 300 may make a request for information on the new trained model to the server 305. The server 305 may transfer the information on the new trained model (e.g., the second model 303) to the electronic device 300 in response to a request of the electronic device 300. The electronic device 300 may update the trained model, based on the information received from the server 305.

According to an embodiment, the server 305 may identify a difference or an improvement between the first model 301-2 and the second model 303 by using the model evaluator 330. The first model 301-2 may refer to the same model as the trained model (first model 301-1) installed in the electronic device 300.

According to an embodiment, the server 305 may update the first model 301-2, which is mounted to the server 305 as an artificial intelligence model, by using the second model 303, before the electronic device 300. According to an embodiment, the server 305 may update the first model 301-2 such that the same output information as the output information output from the second model 303 may be output for the same input information. In addition, the server 305 may acquire information for updating the first model 301-1 of the electronic device 300, based on the updated first model 301-2, and transmit the same to the electronic device 300. Alternatively, the electronic device 300 may transmit, to the electronic device 300, information indicating the difference and the improvement between the first model 301-2 and the second model 303.

According to an embodiment, the improvement may occur when the data distribution input to the trained model changes. Alternatively, the improvement may occur when a particular target class, which is an analysis target of the trained model, has improved. The server 305 may transmit the improved trained model to only the terminal which needs improvement of the corresponding class, based on that the particular target class which is the analysis target of the trained model has improved. The server 305 may not transmit the trained model to a terminal that does not need the improvement of the class, thereby saving resources of the server 305 and the corresponding terminal.

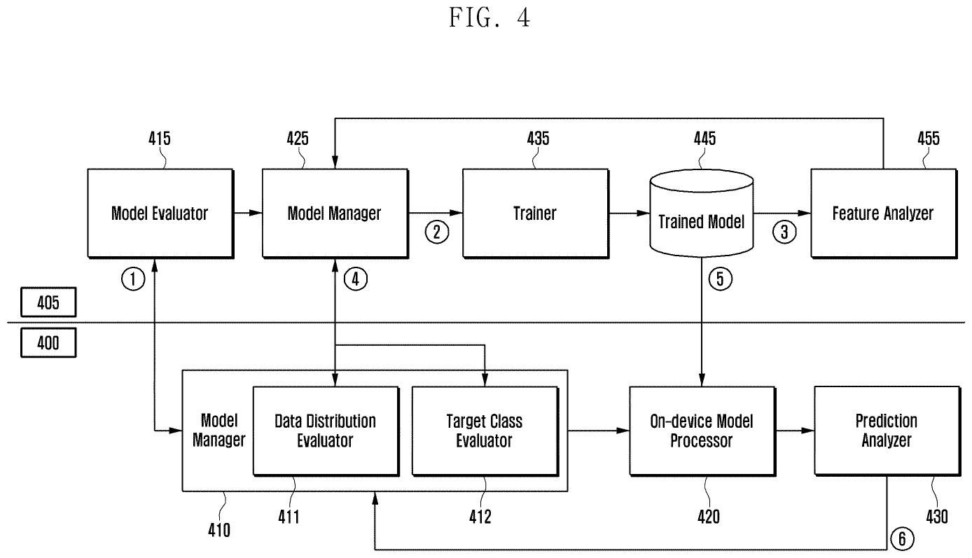

FIG. 4 is a block diagram illustrating a trained model management system according to various embodiments.

The server 405 may include the server 305 in FIG. 3 above. The electronic device 400 may include the electronic device 300 of FIG. 3 above.

In operation (1), a model evaluator 415 of a server 405 (e.g., the server 305 in FIG. 3) may collect a current model performance of an electronic device 400 (e.g., the electronic device 300 in FIG. 3), and determine whether the electronic device 400 needs a new trained model, based on a result of identification of the model performance.

In operation (2), the model evaluator 415 may control a trainer 435 to perform new learning using a model manager 425, based on a determination that a new trained model is needed.

In operation (3), the trainer 435 may train a new trained model 445. A feature analyzer 455 may analyze improvements of a new trained model 445 and the existing trained model and store the same in the model manager 425.

In operation (4), the model manager 425 may compare the existing trained model and the new trained model of the electronic device 400, and transfer the improvements to the electronic device 400. The model manager 410 of the electronic device 400 may determine whether the data distribution of the new trained model is similar to that of the existing trained model by using an input data distribution evaluator 411. The model manager 410 of the electronic device 400 may determine whether a particular target class of the new trained model has improved through the target class evaluator 412, and whether the electronic device 400 needs improvement of the target class in the electronic device 400. According to an embodiment, the electronic device 400 may analyze a use pattern of the user and determine that the improvement of the target class is required, based on that the improved target class is used at a predetermined frequency or higher.

According to an embodiment, the electronic device 400 may transmit information indicating that the new trained model 445 is necessary to the server 405, based on a determination that the new trained model 445 is necessary.

In operation (5), the processor 420 of the electronic device 400 may download the new trained model 445 from the server 405 to update a trained model in the electronic device 400. According to a comparative example, even when there is no need to update the trained model, the electronic device may download the new trained model 445 and waste resources. The electronic device 400 according to various embodiments may determine whether to update the trained model by downloading only the improvement of the new trained model, not the new trained model itself, from the server 405, and download the new trained model 445 without wasting resources.

In operation (6), the electronic device 400 may perform prediction using the trained model by using a prediction analyzer 430, and may transmit feedback data to the model manager 410 of the electronic device 400. The model manager 410 of the electronic device 400 may determine a time point for updating the trained model, based on received feedback data.

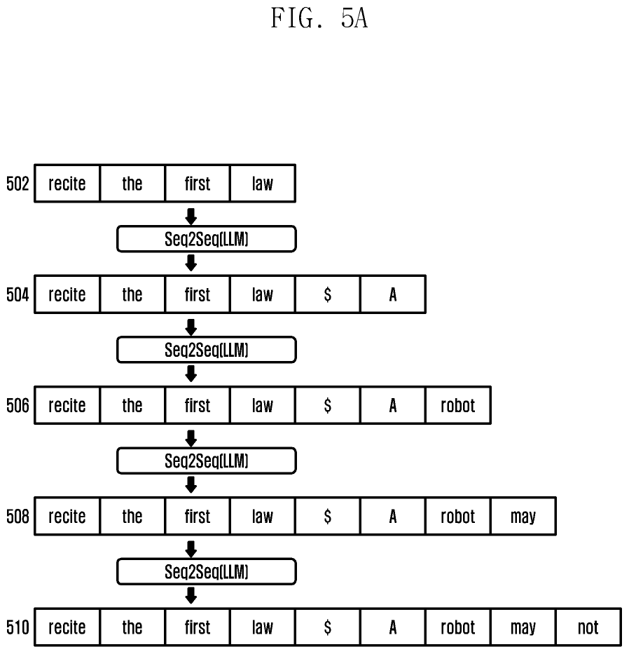

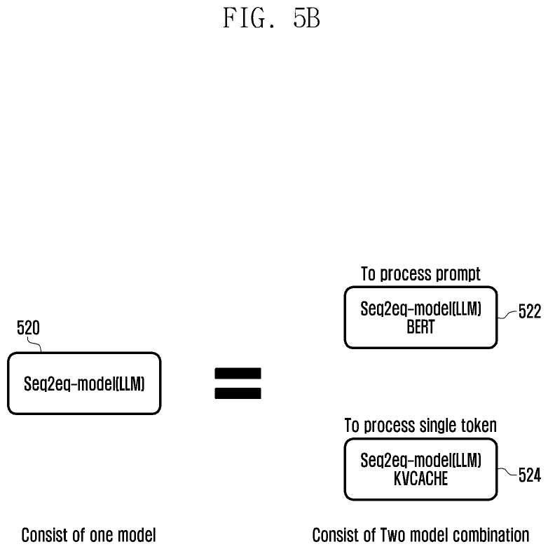

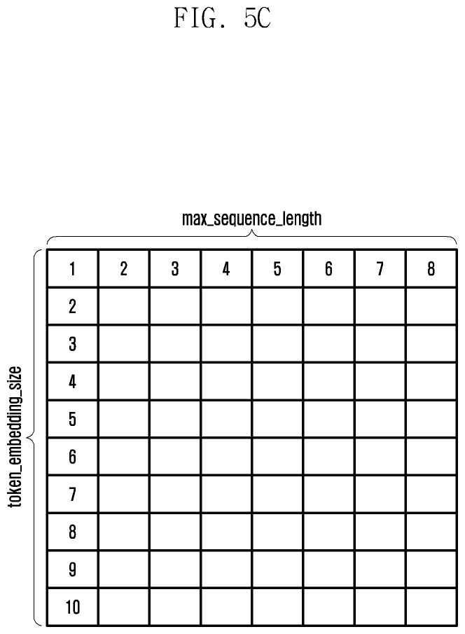

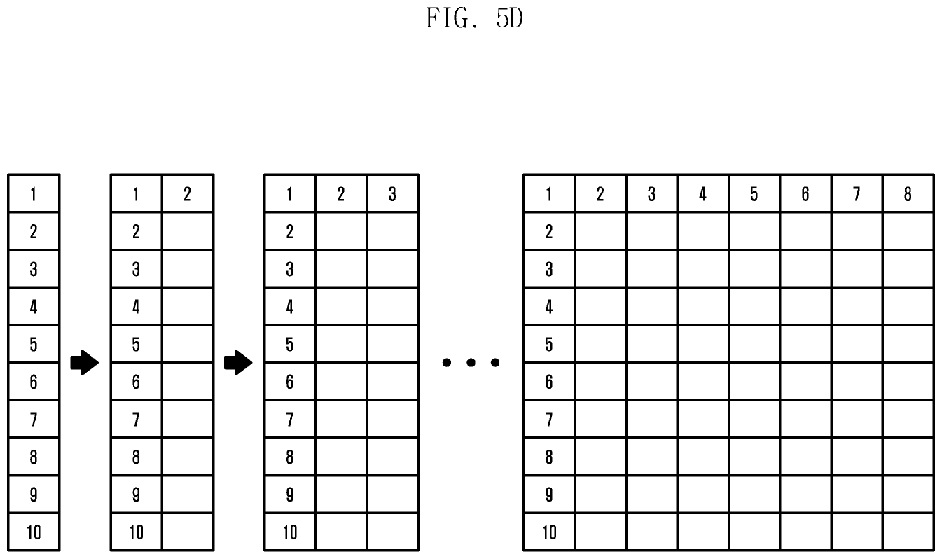

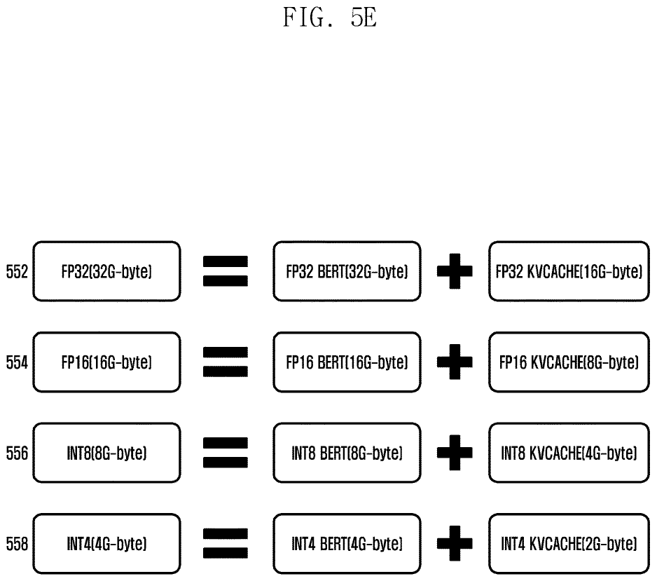

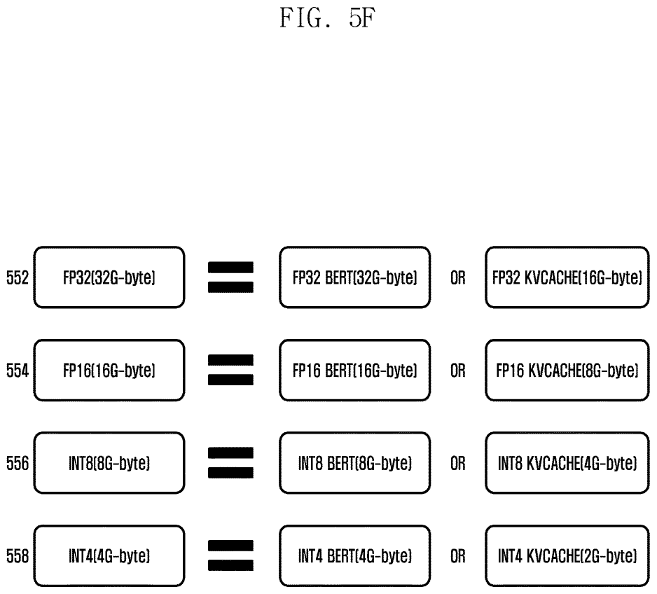

FIG. 5A illustrates a method by which an artificial intelligence model generates a token according to a comparative embodiment.

FIG. 5A illustrates a method by which an artificial intelligence model (e.g., a large language model (LLM)) having a configuration of sequence-to-sequence generates a token. A sequence may refer to a series of data having an order. The sequence to sequence (seq to seq) scheme may refer to a scheme of receiving an input of a sequence that has undergone natural language processing (NLP) and outputting another sequence.

The artificial intelligence model may process a user input inputted in the input prompt at once. Thereafter, the artificial intelligence model may iteratively perform inferences to generate one token at each repeated time point.

For example, as indicated by reference numeral 502, the artificial intelligence model may receive an input of tokens corresponding to recite, the, first, and law. The artificial intelligence model may generate a new token indicating A while performing inference as indicated by reference numeral 504. Thereafter, the artificial intelligence model may generate a new token indicating “robot” as indicated by reference numeral 506 and a new token indicating “may” as indicated by reference numeral 508. The artificial intelligence model may generate a new token indicating “not” as indicated by reference numeral 510. The artificial intelligence model may repeat the inference until an end of sequence (EOS) token indicating that the inference has ended is generated.

In FIG. 5A, the artificial intelligence model may continuously leave the tokens corresponding to recite, the, first, and law in the original size in the memory while repeatedly performing the inference. The artificial intelligence model may continuously leave the tokens corresponding to recite, the, first, and law in the original size in the memory while performing operations 504 to 510 related to the inference. The artificial intelligence model may adjust the weights and reduce the prediction error by repeating the learning.

The artificial intelligence model may generate a single token through a softmax operation while repeating (iterating) the learning. The artificial intelligence model may use a buffer to which a temporary storage space is allocated in order to generate a single token. The softmax operation may refer to an operation that makes it possible to interpret the output values as probabilities. It is used as an activation function of an output layer in a classification problem, and may be used to indicate the probability of belonging to each class. A token may refer to the smallest unit for processing text. A single token may refer to one of multiple tokens. A buffer may refer to an area for temporarily storing data.

The artificial intelligence model may additionally use as much memory as max_sequence_length and token_embedding_size of the LLM model. max_sequence_length may refer to the maximum length of a token that a model can process. token_embedding_size may refer to one of vectors representing a token.

Values generated in each inference (iteration) may have an association with the previous operation result. Due to this association, the artificial intelligence model may have difficulty in performing the next operation when there is no data on the previous operation result. Accordingly, the artificial intelligence model may store both the value of the input prompt and the result of the previously performed repetitive learning in the memory

Values generated by an artificial intelligence model may have an association with the previous operation result. Therefore, the artificial intelligence model may store both the input prompt and the result of previously performed inference in the memory.

FIGS. 5B and 5C illustrate the configuration of an artificial intelligence model according to a comparative embodiment.

In order to use a sequence-to-sequence (seq to seq) scheme, the artificial intelligence model 520 (e.g., LLM) in FIG. 5B may include a prompt executer 522 and a token generator 524. The prompt executer 522 is a model for processing an input prompt and may include, for example, a bidirectional encoder representations from transformers (BERT) model. The token generator 524 may include a key-value (KV) cache. The key-value cache may refer to a cache system that stores intermediate results to perform a particular task relatively quickly. The token generator 524 stores values corresponding to keys as data, and may find values quickly by using the keys.

According to an embodiment, the BERT may bi-directionally process words to consider all the words in a sentence at the same time. The BERT may use a model of transformer to focus on important words and reduce the importance of less important words. The BERT may perform pre-training by using a large amount of text data. The BERT may acquire basic patterns of language through pre-training. The BERT may perform additional training (fine-tuning) for subdivided or specialized tasks. The BERT may use labeled data when performing additional training (fine-tuning).

According to an embodiment, the prompt executor 522 may process only an input prompt. Except for the tokens generated through inference and the data required for the iteration (e.g., the tokens corresponding to recite, the, first, and law in FIG. 5A), the remaining data may be loaded in the memory.

According to an embodiment, the token generator 524 may receive an input of a token generated in the previous inference to generate a next token

FIG. 5C is a diagram illustrating static allocation.

According to an embodiment, in the case of a static allocation scheme, when the length of a sequence is 8 steps and the size of a token is 10 spaces (vectors), memory capacity of 8*10=80 may be required for the corresponding artificial intelligence model to operate. The artificial intelligence model may additionally use as much memory as max_sequence_length and token_embedding_size of the LLM model. max_sequence_length may indicate the maximum length of tokens that a model can process. token_embedding_size may refer to one of vectors representing a token. For example, when max_sequence_length is 8 steps and token_embedding_size is a space (vector) of size 10, the corresponding model may always require 8*10=80 of allocation in order to operate.

That is, even in a situation in which iterative learning is performed, the artificial intelligence model should continuously use data having a size of 80, and thus a relatively large memory capacity may be required compared to dynamic allocation.

FIG. 5D is a diagram illustrating dynamic allocation.

According to an embodiment, in contrast, a dynamic allocation scheme has a structure in which only 10, which is the size of a token, is allocated whenever a new token is generated by performing inference and added to existing information. Therefore, compared to the static allocation scheme requiring a capacity of 80 for every operation, the dynamic allocation scheme can perform learning and inference using a relatively small memory capacity.

The dynamic allocation may have a structure in which 10 of token_embedding_size is allocated in each iterative learning process (iteration) and added to the existing information. According to FIG. 5D, the artificial intelligence model may only assign as much data as 10, which is the size of the token, in the first learning process. In the second learning process, the artificial intelligence model may newly add as much data as 10 for the second column while storing as much data as 10 which has existed. In the case of static allocation, the artificial intelligence model may perform learning by using data having a size of 80(=8×10) in each learning process. The artificial intelligence model performs learning and inference using a relatively small memory capacity compared to static allocation, since only as much data as 10 is added for learning in each learning process.

The artificial intelligence model may perform inference using a relatively smaller memory capacity than the static allocation scheme when an end of sequence (EOS) is generated before max_sequence_length. max_sequence_length may indicate the maximum length of tokens that a model can process. The end of sequence (EOS) may represent a token indicating that the operation has ended. The artificial intelligence model may identify where the input sequence ends by using the EOS.

FIGS. 5E and 5F illustrate a model generated as a single data type according to a comparative embodiment. As indicated by reference numeral 552, the artificial intelligence model may be of the FP32 type and have a size of 32 gigabytes. Since the type of the artificial intelligence model is FP32, the prompt executor (e.g., BERT) and the token generator (e.g., KVACHE) may also use a single data type. The prompt executor may use the FP32 data type, and the token generator may also use the FP32 data type.

As indicated by reference numeral 554, since the type of the artificial intelligence model is FP16, it may be identified that the prompt executor uses the data type of FP16, and the token generator also uses the data type of FP16. According to an embodiment, a model obtained by adding a single model generated in one data type such as 64 bit (FP64, INT64), 32 bit (FP32, INT32), 16 bit (FP16, INT16), 8 bit (FP8, INT8), 4 bit (FP4, INT4), and 2 bit (FP2, INT2), a Bert model, or a Kvcache model may be used. According to an embodiment, only a combination of models having the same data type, such as FP32, FP16, INT8, and INT4, may be configured and stored in a file system.

As indicated by reference numeral 556, since the type of the artificial intelligence model is INT8, it may be identified that the prompt executor uses the INT8 data type, and the token generator also uses the INT8 data type.

As indicated by reference numeral 554, since the type of the artificial intelligence model is INT4, it may be identified that the prompt executor uses the INT4 data type, and the token generator also uses the INT4 data type.

However, according to an actual embodiment, even if the prompt executor and the token generator are determined to be different data types, the operation performance scheme may be the same as the original artificial intelligence model. When the prompt executor and the token generator are determined to be different data types from the original artificial intelligence model, there may be a difference in terms of data processing accuracy, but this may vary according to the type of a task (e.g., translation, reply, typo correction, or summarization) being processed.

When the data type of the original artificial intelligence model is FP32, the prompt executor and the token generator according to the comparative example may use the same FP32 as the original, but may use a different data type from the original in the disclosure. For example, even if the original artificial intelligence model in the disclosure uses FP32, the prompt executor may use the data type of FP16, and the token generator may use the data type of INT8.

When the prompt executor and the token generator use different data types compared to the case in which they use the data type of FP32 in a batch, it is possible to save the memory capacity, reduce the inference time, relatively reduce the power consumption, and reduce the CPU usage. When the prompt executor and the token generator use different data types compared to the case in which they use the data type of FP32 in a batch, there is a disadvantage in that the accuracy of inference may be reduced. However, the required accuracy of inference may differ according to the type of a task (e.g., translation, reply, typo correction, and summarization). Therefore, the electronic device according to the disclosure may determine the accuracy required for each type of the task and determine a first data type of the prompt executor and a second data type of the token generator to be different, thereby reducing the memory usage, reducing power consumption, and improving computational speed while performing tasks without errors. Hereinafter, the first data type may refer to a data type of the prompt executor. The second data type may refer to a data type of the token generator.

According to FIG. 5F, the artificial intelligence model may select one of a prompt executor (e.g., BERT model) or a token generator (e.g., KVcache model) to determine a display style of data.

The artificial intelligence model may have a structure in which the prompt executor (e.g., BERT model) and the token generator (e.g., KVcache model) use a data type determined in advance. Even when the artificial intelligence model is quantized in different data types, the model may have the same operation method as the original (FP32) model, with only a difference in accuracy. Quantization may be used to reduce the size of the artificial intelligence model and to increase the calculation speed. For example, the electronic device may convert a model from 32-bit floating point to 8-bit integer, thereby reducing the size of the artificial intelligence model, reducing the memory usage, and improving the calculation speed.

In addition, the 32-bit/16-bit/8-bit/4-bit/2-bit quantization may show relatively better performance than the 64-bit/32-bit model, compared to the original (64-bit/32-bit) model. Therefore, even when the same original model is used, it is possible to use an artificial intelligence model in which quantization has been performed. The electronic device may configure an artificial intelligence model with different data type combinations optimized for different tasks (e.g., language translation, summarization, typo correction, and reply) to optimize at least one of inference time, power consumption, ROM size, RAM size, RAM transaction, backend utilization, or CPU occupation. The optimization may refer to an operation of maximizing the performance of at least one of inference time, power consumption, ROM size, RAM size, RAM transaction, backend utilization, or CPU occupation.

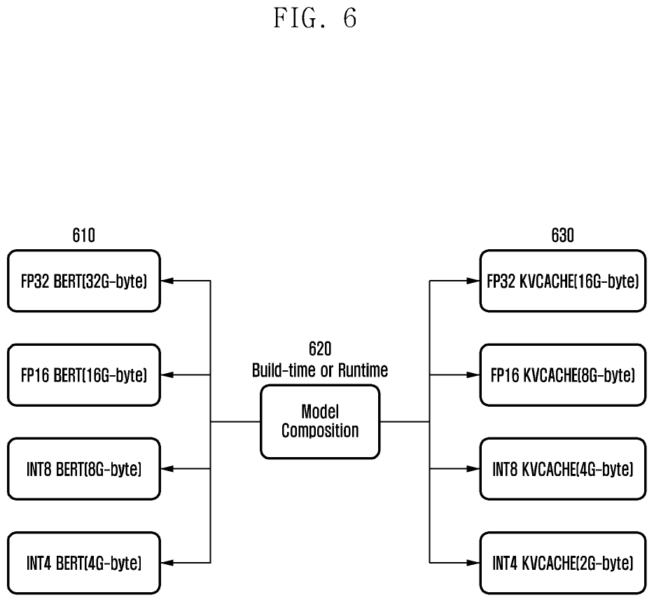

FIG. 6 is a block diagram illustrating a method by which an electronic device configures an artificial intelligence model according to various embodiments.

In FIG. 6, reference numeral 610 is a block diagram illustrating a first data type of an prompt executor. Reference numeral 630 is a block diagram illustrating a second data type of a token generator.

Reference numeral 620 illustrates, as blocks, a process of selecting a data type of the prompt executor and selecting a data type of the token generator in an artificial intelligence model. The model generation as indicated by reference numeral 620 may be executed at build time or at runtime. The build time may indicate a time when an artificial intelligence model is built. The electronic device 300 may define the structure of an artificial intelligence model and train the artificial intelligence model by using trained data during the build time. The runtime may refer to a time required for an artificial intelligence model to run and derive a result. The artificial intelligence model may perform prediction, based on input data after being built through the build time.

The operation of selecting the data type of the prompt executor and selecting the data type of the token generator may be performed by a processor (e.g., the processor 310 in FIG. 3).

According to an embodiment, an electronic device (e.g., the electronic device 300 in FIG. 3) may select a model having a specific data type for model composition during build-time in a situation of performing specific tasks (e.g., language translation, summarization, typo correction, and reply). The electronic device 300 may perform specific tasks by using a method of selectively storing only a specific model in ROM. Alternatively, the electronic device 300 may store an artificial intelligence model having a plurality of data types in ROM and select one of the plurality of data types stored in ROM at runtime, so as to configure a model composition for performing specific tasks.

When performing a specific task, the processor 310 or the electronic device 300 may select the first data type of the prompt executor and select the second data type of the token generator to configure a new artificial intelligence model. When there is a pre-configured condition (rule), the electronic device 300 may determine the type of the first and second data, based on the configured condition, and configure the artificial intelligence model according to the determined data type. When the data type is determined, the artificial intelligence model may perform inference on input data and generate or output a new token.

According to an embodiment, the data type may include FP32, FP16, INT8, INT4, and INT2. The work or task may include one of a language translator, summarization, typo correction, or reply.

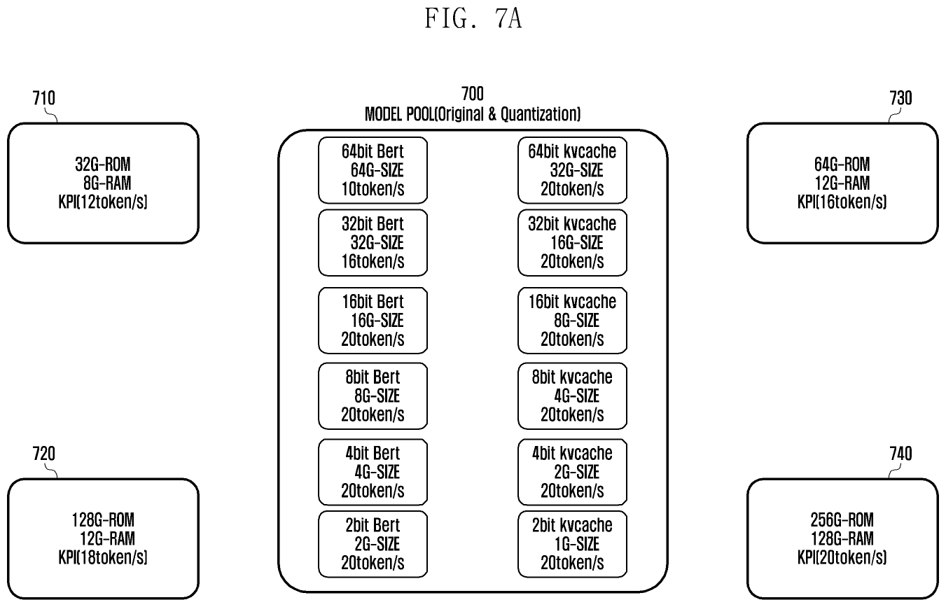

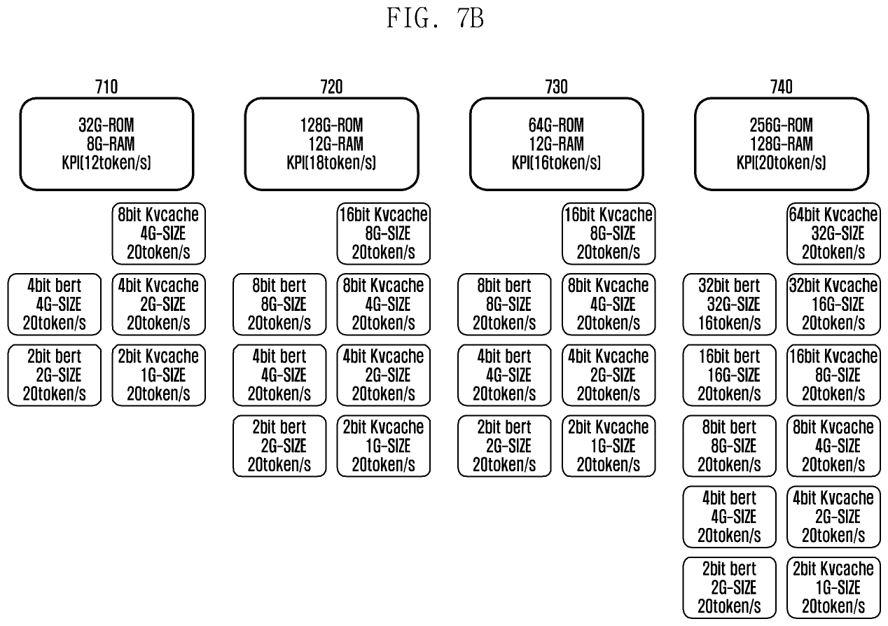

FIGS. 7A and 7B illustrate a process of distinguishing models satisfying performance among combinations of a plurality of artificial intelligence models according to various embodiments.

According to FIG. 7A, an electronic device (e.g., the electronic device 300 in FIG. 3) may configure an artificial intelligence model by using various data types including an original artificial intelligence model. The electronic device 300 may determine a data type of a new artificial intelligence model, based on at least one of the size of a read only memory (ROM), the size of a random access memory (RAM), and a required computational speed (KPI, token/s). The electronic device 300 may determine a data type of the prompt executor and the token generator.

When a preconfigured guide exists for model composition, the electronic device 300 may configure an artificial intelligence model, based on the guide. In a situation in which there is no guide for model composition, the electronic device 300 may configure the artificial intelligence model in consideration of specific components. The specific components may include, for example, a RAM size (ram-size), a backend capability, or a key performance indicator (KPI). The KPI may refer to the number of tokens (token/sec) processed per second by the BERT model or the Kvcache model. For example, the more tokens processed per second by the BERT model, the faster the processing speed of the artificial intelligence model may be. As the processing speed of the artificial intelligence model is faster, the user experience may be improved, and the relatively larger dataset may be processed.

For example, as indicated by reference numeral 710, the electronic device 300 may determine a data type such that the ROM size satisfies 32 gigabytes, the RAM size satisfies 8 gigabytes, and the computational speed satisfies 12 token/s. The ROM size, the RAM size, and the computational speed are only examples, and the condition considered by the electronic device 300 to determine the data type are not limited thereto. The electronic device 300 may consider the performance for each combination of data. An index indicating the performance for each combination of data may include, for example, at least one of the memory size, the backend capability, the computational speed (key performance indicators (KPIs)), the power consumption, or the inference accuracy. As indicated by reference numeral 710, the electronic device 300 may generate a model pool by collecting all data types that satisfy the ROM size of 32 gigabytes, the RAM size of 8 gigabytes, and the computational speed of 12 token/s. The model pool will be described in FIG. 7B.

As indicated by reference numeral 720, the electronic device 300 may determine a data type such that the ROM size satisfies 128 gigabytes, the RAM size satisfies 12 gigabytes, and the computational speed satisfies 18 token/s.

As indicated by reference numeral 730, the electronic device 300 may determine a data type such that the ROM size satisfies 64 gigabytes, the RAM size satisfies 12 gigabytes, and the computational speed satisfies 16 token/s.

As indicated by reference numeral 740, the electronic device 300 may determine a data type such that the ROM size satisfies 256 gigabytes, the RAM size satisfies 128 gigabytes, and the computational speed satisfies 20 token/s.

The values and elements mentioned by reference numerals 710 to 740 are only examples. A numerical value for determining the data type used in the artificial intelligence model may be configured differently according to the type of task to be performed. Elements for determining the data type used in the artificial intelligence model may vary according to user settings.

FIG. 7B is a block diagram illustrating combinations of data types that satisfy conditions required to determine a data type.

For example, as indicated by reference numeral 710, the electronic device 300 may determine a data type such that the ROM size satisfies 32 gigabytes, the RAM size satisfies 8 gigabytes, and the computational speed satisfies 12 token/s. The combination of data types satisfying the condition as indicated by reference numeral 710 may include, for example, a case in which the prompt executor (e.g., BERT model) has a data type of INT4 and the token generator (e.g., KVcache model) has a data type of INT8. Alternatively, when the prompt executor may have one of the data types of INT2 and INT4, and the token generator may have one of the data types of INT2, INT4, and INT8, the condition as indicated by reference numeral 710 may be satisfied.

According to an embodiment, the prompt executor may have a data type of INT 4 (4 bits), a size of 4 gigabytes (G), and a specification of processing 20 tokens per second. The token generator may have a data type of INT4 (4 bits), a size of 2 gigabytes, and a specification of processing 20 tokens per second. When the prompt executor and the token generator satisfy these specifications, the condition as indicated by reference numeral 710 may be satisfied. This is only an example, and a combination of the prompt executor and the token generator that satisfies the condition as indicated by reference numeral 710 is not limited thereto.

The electronic device 300 may identify the specifications of the prompt executor and the token generator, and generate a model composition, based on the required condition (e.g., the condition as indicated by reference numeral 710). The electronic device 300 may determine a candidate group of the prompt executor and the token generator that satisfies the specification according to at least one of the KPI, the memory capacity, the power consumption, or the inference accuracy. The electronic device 300 may perform an auto composition of automatically selecting one from among the candidate group of the prompt executor and the token generator that satisfies the specification. For example, two types of the prompt executor satisfying the specification as indicated by reference numeral 710 are illustrated. Three types of the token generator satisfying the specification as indicated by reference numeral 710 are illustrated. The electronic device 300 may select one of the two types of the prompt executor and select one of the three types of the token generator to perform the auto composition. According to an embodiment, the electronic device 300 may determine a specification of an artificial intelligence model including reference numerals 710 to 740 according to the type of a task to be performed. The specifications of the artificial intelligence models illustrated in FIG. 7B are merely examples and are not limited to reference numerals 710 to 740. The data type of the prompt executor and the data type of the token generator may be determined differently, according to the specification of the artificial intelligence model. The electronic device 300 may determine the specification of the artificial intelligence model according to the type of the task to be performed, and may determine the data type of the prompt executor and the data type of the token generator differently, according to the specification of the artificial intelligence model.

According to an embodiment, the higher the specification of the artificial intelligence model, the more types of combinable data may be increased. For example, as indicated by reference numeral 710, the ROM size satisfies 32 gigabytes, the RAM size satisfies 8 gigabytes, and the computational speed satisfies 12 tokens/s, and thus the specification may be relatively low in comparison with reference numeral 740. As indicated by reference numeral 710, the prompt executor may have one of the data types of INT2 and INT4, and the token generator may have one of the data types of INT2, INT4, and INT8.

In contrast, as indicated by reference numeral 740, the specification of the allowed artificial intelligence model is relatively good, and thus a relatively larger number of data types may be combined as compared to reference numeral 710. For example, as indicated by reference numeral 740, the prompt executor may have one of the data types of INT2, INT4, INT8, FP16, and FP32, and the token generator may have one of the data types of INT2, INT4, INT8, FP16, FP32, and FP64.

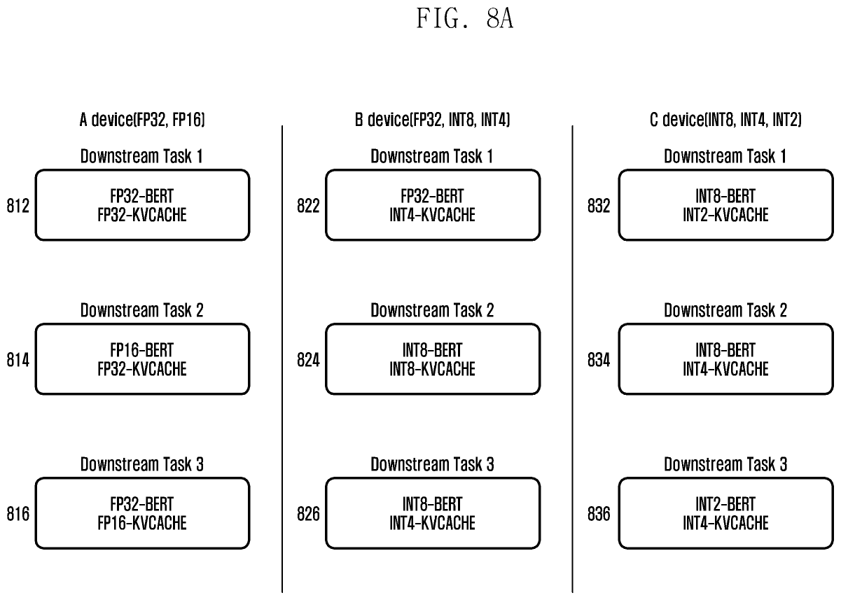

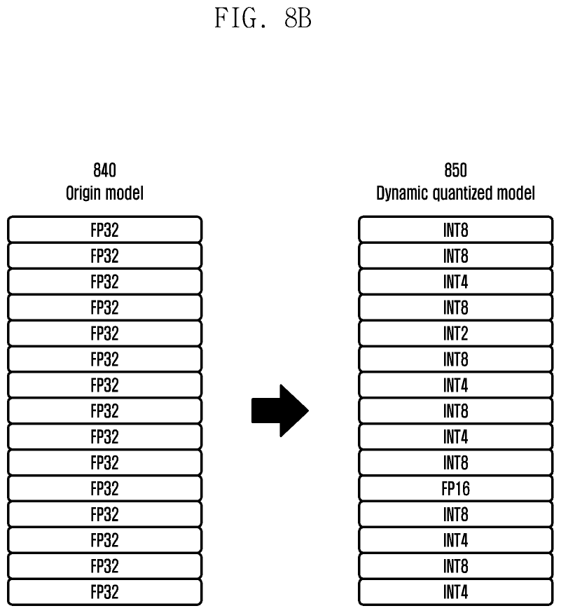

FIGS. 8A and 8B illustrate an embodiment in which an electronic device according to various embodiments configures different artificial intelligence models according to performance for the same task.

FIG. 8A illustrates an embodiment in which the configuration of an artificial intelligence model is different when different electronic devices 810, 820, and 830 process the same type of task.

The first electronic device 810 may have a data type of FP32 or FP16 in FIG. 8A. As indicated by reference numeral 812, the first electronic device 810 may determine that the first data type of the prompt executor is FP32 and determine that the second data type of the token generator is FP32 when processing the first task. Among artificial intelligence models, a conventional model may have the same data type configured regardless of the performance of the electronic device 300. Among the artificial intelligence models, a dynamic model may have different data types configured according to the performance of the electronic device 300.

As indicated by reference numeral 814, the first electronic device 810 may determine that the first data type of the prompt executor is FP16 and determine that the second data type of the token generator is FP32 when processing the second task.

As indicated by reference numeral 816, the first electronic device 810 may determine that the first data type of the prompt executor is FP32 and determine that the second data type of the token generator is FP16 when processing a third task. This is only an example, and the first data type of the prompt executor and the second data type of the token generator may differ according to the specification of the first electronic device 810 and the specification required for the task being performed.

In FIG. 8A, the second electronic device 820 may have a data type of FP32, INT8, or INT4. In this case, as indicated by reference numeral 822, the second electronic device 820 may determine that the first data type of the prompt executor is FP32 and that the second data type of the token generator is INT4 when processing the first task.

As indicated by reference numeral 824, the second electronic device 820 may determine that the first data type of the prompt executor is INT8 and that the second data type of the token generator is INT8 when processing the second task.

As indicated by reference numeral 826, the second electronic device 820 may determine that the first data type of the prompt executor is INT8 and that the second data type of the token generator is INT4 when processing the third task. This is only an example, and the first data type of the prompt executor and the second data type of the token generator may differ according to the specification of the second electronic device 820 and the specification required for the task being performed.

In FIG. 8A, the third electronic device 830 may have a data type of INT8, INT4, or INT2. As indicated by reference numeral 832, the third electronic device 830 may determine that the first data type of the prompt executor is INT8 and that the second data type of the token generator is INT2 when processing the first task.

In FIG. 8A, a model composition scheme for performing a task may differ for each electronic device (e.g., a terminal or a computer). For example, in a situation in which the first electronic device (A device) 810 supports only data types of FP32 and FP16, an artificial intelligence model for performing a specific task (e.g., translation) may be configured as indicated by reference numeral 812. In contrast, in a situation in which the second electronic device (B device) 820 further supports data types of INT 8 and INT 4 in additional to FP32, an artificial intelligence model for performing a specific task (e.g., translation) may be configured as indicated by reference numeral 822. In a situation in which the third electronic device (C device) 830 supports INT 8, INT 4, and INT 2, an artificial intelligence model for performing a specific task (e.g., translation) may be configured as indicated by reference numeral 832. Even if the respective electronic devices are the same, the configuration of the artificial intelligence model may vary depending on the type of task (e.g., task 1, task 2, or task 3).

The respective electronic devices (e.g., A, B, and C devices) may have difference in configurations of the prompt executor (e.g., BERT model) and the token generator (e.g., KVcache model) depending on a preconfigured guide or a resource condition (e.g., memory capacity) even for the same task. However, even if the configurations of the prompt executor and the token generator differ, the results of inference and output of the artificial intelligence model may satisfy the KPI in respective electronic devices. In addition, different electronic devices may perform learning and inference by using one original model. Inference may refer to a process of predicting new data by using a trained model. The artificial intelligence model may apply patterns learned in a learning stage to new data and output a predicted value. The result of inference may vary depending on the performance (e.g., accuracy or speed) of the artificial intelligence model. As indicated by reference numeral 834, the third electronic device 830 may determine that the first data type of the prompt executor is INT8 and that the second data type of the token generator is INT4 when processing the second task.

As indicated by reference numeral 836, the third electronic device 830 may determine that the first data type of the prompt executor is INT2 and that the second data type of the token generator is INT4 when processing the third task. This is only an example, and the first data type of the prompt executor and the second data type of the token generator may differ according to the specification of the third electronic device 830 and the specification required for the task being performed.

FIG. 8B illustrates an embodiment of the disclosure in which an artificial intelligence model that performs inference by stacking the same layers differently determines the data types of the prompt executor and the token generator.

According to an embodiment, when the electronic device quantizes and uses models having large-sized data, a KPI close to the original model may be achieved as compared to the case in which an artificial intelligence model is configured using a single data type. In addition, when the electronic device quantizes and uses models having large-sized data, the data size becomes relatively smaller, so that the size of RAM or ROM may be saved.

According to an embodiment, even if the configurations of the prompt executor and the token generator are different, the inference and output results of the artificial intelligence model may satisfy the KPIs required by the respective electronic devices. Different electronic devices may perform learning and inference by using one original model and acquire a uniform KPI.

The original artificial intelligence model 840 may configure a neural network by stacking a plurality of layers having one data type (e.g., FP32) and perform inference. Although the description in FIG. 8B has been made based on the assumption that the data type is FP32, the data type that the original artificial intelligence model 840 may have is not limited thereto. However, the original artificial intelligence model 840 may be configured such that all of the plurality of layers have the same data type.

On the other hand, the electronic device (e.g., the electronic device 300 in FIG. 3) according to the disclosure may determine that each of the plurality of layers has a different data type for the artificial intelligence model 850 configuring the neural network by stacking the plurality of layers. In addition, not only layer having a stack structure, but also each of the operations may be determined to have independent various data types. The electronic device 300 may test the output of the artificial intelligence model by using various data types not only in the layers but also in the process of performing the operation. The electronic device 300 may determine a data type having the best performance by testing the output of the artificial intelligence model during the process of performing the operation. That is, a plurality of operations may have different data types rather than a single data type.

For example, the electronic device 300 may determine that one layer has a data type of INT8 and that another layer has a data type of INT4. The electronic device 300 may determine that another layer has a data type of FP16. The plurality of layers may be combined to form a transformer The transformer may learn a sentence by using an attention mechanism that assigns more attention to important words and less attention to less important words. The original artificial intelligence model 840 according to the comparative embodiment may have the form in which layers of the same data type are stacked. On the other hand, the artificial intelligence model 850 according to various embodiments of the disclosure may have the form in which layers having different data types are stacked.

According to an embodiment, inference may refer to a process of predicting new data by using a trained model. The artificial intelligence model may apply patterns learned in a learning stage to new data to output a predicted value. The result of inference may vary depending on the performance (e.g., accuracy or speed) of the artificial intelligence model.

According to an embodiment, when a type of a task to be executed is determined and when there is a preconfigured condition for the first and second data, the electronic device 300 may determine types of the first data and second data, based on the preconfigured condition, and configure the artificial intelligence model and perform inference according to the determined data type.

According to an embodiment, when a type of a task to be executed has been determined but there is no condition previously configured for the first data and the second data, the electronic device 300 may perform inference through the artificial intelligence model to measure the performance for each data combination while changing the types of the first data and the second data. The electronic device 300 may configure the artificial intelligence model with a combination having the relatively best performance. The performance for each combination of data may include at least one of the memory size, the backend capability, the computational speed (key performance indicators (KPIs)), the power consumption, or the inference accuracy. The KPI may refer to the number of tokens (token/sec) processed per second by the BERT model or the Kvcache model. For example, the more tokens processed per second by the BERT model, the faster the processing speed of the artificial intelligence model may be.

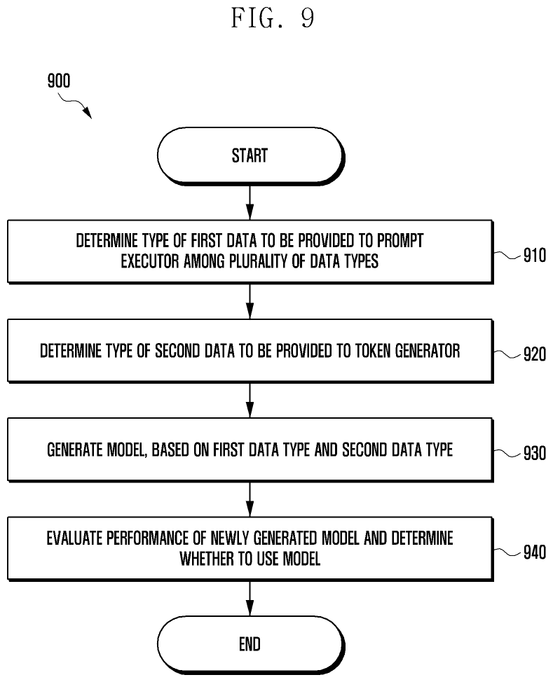

FIG. 9 is a flowchart illustrating a method by which an electronic device configures an artificial intelligence model according to various embodiments.

The operations described through FIG. 9 may be implemented based on instructions that may be stored in a computer recording medium or memory (e.g., the memory 130 in FIG. 1). The illustrated method 900 may be executed by the electronic device (e.g., the electronic device 300 in FIG. 3) described above with reference to FIGS. 1 to 8B, and the technical features that have been described above will be omitted in the following description. The sequences of the operations in FIG. 9 may be changed, some operations may be omitted, and some operations may be simultaneously performed.

In operation 910, the electronic device 300 or the processor (e.g., the processor 310 in FIG. 3) may determine s type of first data to be provided to the prompt executor among a plurality of data types. The prompt executor may refer to a configuration of executing a user prompt. The prompt executer is a model for processing an input prompt and may include, for example, a bidirectional encoder representations from transformers (BERT) model.

In operation 920, the electronic device 300 may determine a type of second data to be provided to the token generator. The token generator may include a configuration of generating a single token. The token generator may include a key-value (KV) cache. The key-value cache may refer to a cache system that stores intermediate results to perform a particular task relatively quickly. The token generator 524 stores values corresponding to keys as data, and may find values quickly by using the keys.

In operation 930, the electronic device 300 may generate an artificial intelligence model, based on the first data type and the second data type. The conventional artificial intelligence model may be referred to as a first artificial intelligence model. The artificial intelligence model generated based on the first data type and the second data type may be referred to as a second artificial intelligence model. The first data type may refer to a data type of the prompt executor. The second data type may refer to a data type of the token generator. According to an embodiment, the data type may include FP32, FP16, INT8, INT4, and INT2.

In operation 940, the electronic device 300 may evaluate the performance of the newly generated second artificial intelligence model and determine whether to use the same or not.

The first artificial intelligence model may measure at least one of the accuracy, the memory usage, or the computational speed and store the same in the memory. The accuracy of the artificial intelligence model may be determined according to a ratio of results that match the correct answer among the output results. The correct answer may be determined differently depending on a data set input to the artificial intelligence model. For example, when learning to distinguish between a cat and a puppy is performed, a label of “cat” or “puppy” may match each image. The accuracy of the artificial intelligence model may be determined according to the ratio of how much the predicted value of the artificial intelligence model matches the actual label.

The first artificial intelligence model may compare at least one of the accuracy, the memory usage, or the computational speed of the second artificial intelligence model. For example, the first artificial intelligence model may determine to use the newly generated second artificial intelligence model when the second artificial intelligence model has a relatively higher accuracy than the first artificial intelligence model. The accuracy, the memory usage, or the computational speed are only examples, and indexes for comparing the performance between artificial intelligence models are not limited thereto.

According to an embodiment, the electronic device 300 may determine the type of the first data to be provided to the prompt executor and the type of the second data to be provided to the token generator among the plurality of data types through a table stored in the memory. The table may include a table in which the accuracy of each model is scored when a plurality of models are composed and/or provided based on the type of the first data and the second data.

According to an embodiment, the electronic device 300 may determine the type of the first data to be provided to the prompt executor and the type of the second data to be provided to the token generator for each work or task, among the plurality of data types, based on a table in which the accuracy is scored for each model. The work or task may include one of a language translator, summarization, typo correction, or reply. The work or task is only an example and is not limited thereto.

According to an embodiment, when there is no table corresponding to a task to be performed, the electronic device 300 may identify a resource of the electronic device. The electronic device 300 may, based on that the remaining resource exceeds a designated level, measure the memory usage and the computational speed for each model when a plurality of models are composed and/or provided based on the type of the first data and the second data. The electronic device 300 may determine a combination with the fastest computational speed among combinations of data types having memory usage smaller than the remaining resources of the electronic device, and perform inference and a task by using a model configured by the determined combination.

According to an embodiment, when a type of the task to be executed is determined and when there is a preconfigured condition for the first data and the second data, the electronic device 300 may determine types of the first data and second data, based on the preconfigured condition, and configure the artificial intelligence model and perform inference according to the determined data type.

According to an embodiment, when a type of a task to be executed has been determined but there is no condition previously configured for the first data and the second data, the electronic device 300 may perform inference through the artificial intelligence model to measure the performance for each data combination while changing the types of the first data and the second data. The electronic device 300 may configure the artificial intelligence model with a combination having the relatively best performance. The performance for each combination of data may include at least one of the memory size, the backend capability, the computational speed (key performance indicators (KPIs)), the power consumption, or the inference accuracy.

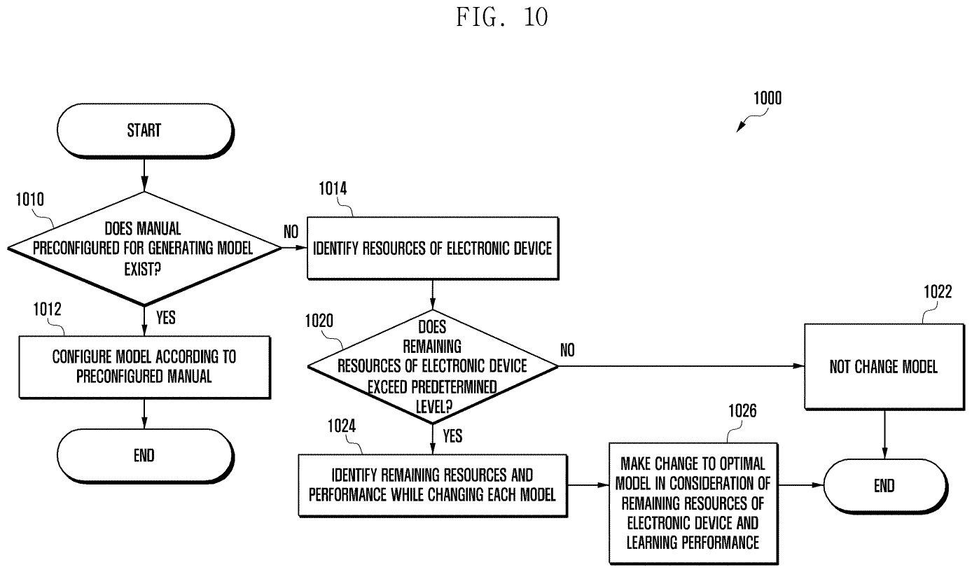

FIG. 10 is a flowchart illustrating a method by which an electronic device configures an artificial intelligence model according to various embodiments.

The operations described through FIG. 10 may be implemented based on instructions which may be stored in a computer recording medium or a memory (e.g., the memory 130 in FIG. 1). The illustrated method 1000 may be executed by the electronic device (e.g., the electronic device 300 in FIG. 3) described above with reference to FIGS. 1 to 8B, and the technical features that have been described above will be omitted in the following description. The sequences of the operations in FIG. 10 may be changed, some operations may be omitted, and some operations may be simultaneously performed.

In operation 1010, the electronic device 300 may identify whether a manual preconfigured for generating the artificial intelligence model exists. When there is a combination of data types that satisfies the specification (e.g., computational speed, memory capacity, and the like) required for each work (or task), the electronic device 300 may configure a manual to make a change to the corresponding combination Alternatively, the manual may be changed according to user settings.

In operation 1012, the electronic device 300 may configure an artificial intelligence model according to the pre-configured manual, based on that the manual pre-configured for generating the artificial intelligence model exists. The artificial intelligence model may include a prompt executor and a token generator. An operation of configuring the artificial intelligence model may indicate an operation of determining data types used by the prompt executor and the token generator.

In operation 1014, the electronic device 300 may identify resources of the electronic device 300, based on that the manual preconfigured for generating the artificial intelligence model does not exist. The resources of the electronic device 300 may include, for example, the CPU capacity or the memory capacity.

In operation 1020, the electronic device 300 may determine whether the remaining resources exceed a predetermined level. The predetermined level may be determined differently, for example, according to the specification (e.g., computing speed, memory capacity, and the like) required for each work (task). When the specification for each work (or task) is high, the task may be a high-degree task, in which case a relatively large amount of remaining resources may be required. The electronic device 300 may maintain the artificial intelligence model without changing the same only when the remaining resources are relatively large, by relatively increasing the predetermined level for a task requiring a high specification. Conversely, when the remaining resources are relatively small, the artificial intelligence model may be changed. The predetermined level may vary depending on user settings.

In operation 1024, the electronic device 300 may identify the remaining resources and the performance while changing the data type of the artificial intelligence model, based on that the remaining resources exceed the predetermined level. The performance may include, for example, at least one of the memory size, the backend capability, the computational speed (key performance indicators (KPIs)), the power consumption, or the inference accuracy.

In operation 1026, the electronic device 300 may determine a data type in consideration of the remaining resources and the performance, and newly generate an optimal model or maintain the existing model. An operation of generating an optimal model may indicate an operation of determining the data types used by the prompt executor and the token generator in a different manner from the original artificial intelligence model.

In operation 1022, the electronic device 300 may end the operation without changing the data type of the artificial intelligence model, based on that the remaining resources are less than the predetermined level.

According to an embodiment, an electronic device may include a memory configured to store a first artificial intelligence model and a processor, wherein the first artificial intelligence model may include a prompt executor configured to execute a user prompt, and a token generator configured to generate a single token, and wherein the processor may be configured to, based on that instructions stored in the memory are executed, measure and store, in the memory, at least one of accuracy, memory usage, or computational speed of the first artificial intelligence model, determine a type of first data to be provided to the prompt executor among a plurality of data types, determine a type of second data to be provided to the token generator, generate a second artificial intelligence model, based on the type of the first data and the type of the second data, and determine whether to use the second artificial intelligence model by comparing at least one of accuracy, memory usage, or computational speed of the second artificial intelligence model with the first artificial intelligence model.

According to an embodiment, the plurality of data types may include FP32, FP16, INT8, INT4, and INT2.

According to an embodiment, the processor may be configured to, by a table stored in the memory, determine the type of the first data to be provided to the prompt executor among the plurality of data types and determine the type of the second data to be provided to the token generator The table may include a table in which accuracy is scored for each model when a plurality of models are composed and/or provided based on the type of the first data and the second data, and the accuracy of the first artificial intelligence model and the second artificial intelligence model may be determined according to a ratio of results matching a correct answer among output results.

According to an embodiment, the processor may be configured to determine the type of the first data to be provided to the prompt executor for each task among the plurality of data types by the table in which the accuracy is scored for each model. The table may include a table in which accuracy is scored for each model when a plurality of models are composed and/or provided based on the type of the first data and the second data, and the accuracy of the first artificial intelligence model and the second artificial intelligence model may be determined according to a ratio of results matching a correct answer among output results.

According to an embodiment, the processor may determine the type of the first data to be provided to the prompt executor for each task among the plurality of data types, based on the table in which the accuracy is scored for each model and determine the type of the second data to be provided to the token generator. The task may include one of a language translator, summarization, typo correction, or a reply.

According to an embodiment, the processor may be configured to identify resources of the electronic device in case that a table corresponding to a task to be performed does not exist, measure a usage and computational speed of the memory for each model in case that the plurality of models are composed and/or provided based on the type of the first data and the second data, based on that remaining resources of the electronic device exceed a predetermined level, determine a combination of data types having a fastest computational speed among combinations of data types having memory usage relatively smaller than the remaining resources of the electronic device, and perform inference and a task by using models composed by the determined combinations. “Based on” as used herein covers based at least on.

According to an embodiment, the processor may be configured to, when a type of a task to be executed is determined and there are conditions preconfigured for the first data and the second data, determine the types of the first data and the second data, based on the preconfigured conditions, and configure the artificial intelligence model according to the determined data types and perform inference.

According to an embodiment, the processor may be configured to, when a type of a task to be executed is determined but there is no condition preconfigured for the first data and the second data, measure a performance for each combination of data by performing inference through the artificial intelligence model while changing the types of the first data and the second data and configure the artificial intelligence model with a combination having a relatively best performance The performance for each combination of data may include at least one of a size of the memory, a capability of a backend, key performance indicators (KPI), power consumption, or accuracy of inference.

Embodiments of the disclosure in the specifications and drawings are specific examples presented only to easily describe the technical content according to the embodiments of the disclosure and help understanding of the embodiments of the disclosure, and do not limit the scope of the embodiments of the disclosure. Therefore, the scope of the embodiment of the disclosure should also be interpreted as including all modifications or variants derived from the technical idea of the embodiment of the disclosure, in addition to the embodiments described in the disclosure.

1. An electronic device comprising:
a memory configured to store instructions and a first artificial intelligence model; and
at least one a processor comprising processing circuitry,
wherein the first artificial intelligence model comprises:
a prompt executor configured to execute a user prompt; and
a token generator configured to generate a single token, and
wherein the instructions, when executed individually and/or collectively by the at least one processor, cause the electronic device to perform control to:
measure and store, in the memory, at least one of accuracy, memory usage, or computational speed of the first artificial intelligence model;
determine a type of first data to be provided to the prompt executor among a plurality of data types;
determine a type of second data to be provided to the token generator;
generate a second artificial intelligence model, based on the type of the first data and the type of the second data; and
compare at least one of accuracy, memory usage, or computational speed of the second artificial intelligence model with the first artificial intelligence model to determine whether to use the second artificial intelligence model.

2. The electronic device of claim 1, wherein the plurality of data types comprise FP32, FP16, INT8, INT4, and INT2.

3. The electronic device of claim 1, wherein the instructions, when executed individually and/or collectively by the at least one processor, cause the electronic device to perform control to, by a table stored in the memory:
determine the type of the first data to be provided to the prompt executor among the plurality of data types; and
determine the type of the second data to be provided to the token generator,
wherein the table comprises a table in which accuracy is scored for each model when a plurality of models are based on the type of the first data and the second data, and
wherein the accuracy of the first artificial intelligence model and the second artificial intelligence model is determined according to a ratio of results matching a correct answer among output results.

4. The electronic device of claim 3, wherein the instructions, when executed individually and/or collectively by the at least one processor, cause the electronic device to perform control to:
determine, for each task, the type of the first data to be provided to the prompt executor among the plurality of data types, based on the table in which the accuracy is scored for each model; and
determine the type of the second data to be provided to the token generator, and
wherein the task comprises one of language translator, summarization, typo correction, or reply.

5. The electronic device of claim 3, wherein the instructions, when executed individually and/or collectively by the at least one processor, cause the electronic device to perform control to:
in case that a table corresponding to a task to be performed does not exist, identify resources of the electronic device;
based on remaining resources of the electronic device that exceed a predetermined level, measure the memory usage and the computational speed for each model when the plurality of models are based on the type of the first data and the second data,;
determine a combination of data types having fastest computational speed among combinations of data types having memory usage relatively smaller than the remaining resources; and
perform inference and a task by using models composed by the determined combination.

6. The electronic device of claim 1, wherein the instructions, when executed individually and/or collectively by the at least one processor, cause the electronic device to perform control to:
in case that a type of a task to be performed is determined and there are preconfigured conditions for the first data and the second data, determine the types of the first data and the second data, based on the preconfigured conditions; and
provide the artificial intelligence model according to the determined data types and perform inference.

7. The electronic device of claim 1, wherein the instructions, when executed individually and/or collectively by the at least one processor, cause the electronic device to perform control to:
in a case that a type of a task to be performed is determined but there are no preconfigured conditions for the first data and the second data,
measure performance for each combination of data at least by performing inference through the artificial intelligence model while changing the types of the first data and the second data; and
provide the artificial intelligence model by a combination having relatively best performance, and
wherein the performance for each combination of data comprises at least one of a size of the memory, capability of a backend, key performance indicators (KPI), power consumption, or accuracy of inference.

8. An operation method comprising:
measuring and storing, in a memory, at least one of accuracy, memory usage, or computational speed of a first artificial intelligence model;
determining a type of first data to be provided to a prompt executor among a plurality of data types;
determining a type of second data to be provided to a token generator;
generating a second artificial intelligence model, based on the type of the first data and the type of the second data; and
comparing at least one of accuracy, memory usage, or computational speed of the generated second artificial intelligence model with the first artificial intelligence model to determine whether to use the second artificial intelligence model.

9. The operation method of claim 8, wherein the plurality of data types comprise FP32, FP16, INT8, INT4, and INT2.

10. The operation method of claim 8, further comprising:
determining the type of the first data to be provided to the prompt executor among the plurality of data types by a table stored in the memory; and
determining the type of the second data to be provided to the token generator,
wherein the table comprises a table in which accuracy is scored for each model when a plurality of models are based on the type of the first data and the second data, and
wherein the accuracy of the first artificial intelligence model and the second artificial intelligence model is determined according to a ratio of results matching a correct answer among output results.

11. The operation method of claim 10, further comprising:
determining, for each task, the type of the first data to be provided to the prompt executor among the plurality of data types, based on the table in which the accuracy is scored for each model; and
determining the type of the second data to be provided to the token generator,
wherein the task comprises one of language translator, summarization, typo correction, or reply.

12. The operation method of claim 10, further comprising:
in a case that a table corresponding to a task to be performed does not exist, identifying resources of the electronic device;
based on remaining resources of the electronic device that exceed a predetermined level, measuring the memory usage and the computational speed for each model when the plurality of models are based on the type of the first data and the second data,;
determining a combination of data types having fastest computational speed among combinations of data types having memory usage relatively smaller than the remaining resources; and
performing inference and a task by using models composed by the determined combination.

13. The operation method of claim 8, further comprising:
in a case that a type of a task to be performed is determined and there are preconfigured conditions for the first data and the second data, determining the types of the first data and the second data, based on the preconfigured conditions; and
providing the artificial intelligence model according to the determined data types and performing inference.

14. The operation method of claim 8, further comprising:
in case that a type of a task to be performed is determined but there are no preconfigured conditions for the first data and the second data, measuring performance for each combination of data by performing inference through the artificial intelligence model while changing the types of the first data and the second data; and
newly providing the artificial intelligence model by a combination having relatively best performance,
wherein the performance for each combination of data comprises at least one of a size of the memory, capability of a backend, key performance indicators (KPI), power consumption, or accuracy of inference.

15. A non-transitory recording medium comprising:
a memory configured to store a first artificial intelligence model; and
wherein the first artificial intelligence model comprises:
a prompt executor configured to execute a user prompt; and
a token generator configured to generate a single token, and
wherein the memory is configured to store instructions that, when executed, control a processor, comprising one or more processors and processing circuitry, to:
measure and store, in the memory, at least one of accuracy, memory usage, or computational speed of the first artificial intelligence model;
determine a type of first data to be provided to the prompt executor among a plurality of data types;
determine a type of second data to be provided to the token generator;
generate a second artificial intelligence model, based on the type of the first data and the type of the second data; and
compare at least one of accuracy, memory usage, or computational speed of the second artificial intelligence model with the first artificial intelligence model to determine whether to use the second artificial intelligence model.

16. The recording medium of claim 15, wherein the plurality of data types comprise FP32, FP16, INT8, INT4, and INT2.

17. The recording medium of claim 15, wherein the processor is configured to, via at least a table stored in the memory:
determine the type of the first data to be provided to the prompt executor among the plurality of data types; and
determine the type of the second data to be provided to the token generator,
wherein the table comprises a table in which accuracy is scored for each model when a plurality of models are provided based on the type of the first data and the second data, and
wherein the accuracy of the first artificial intelligence model and the second artificial intelligence model is determined according to a ratio of results matching a correct answer among output results.

18. The recording medium of claim 17, wherein the processor is configured to:
determine, for each task, the type of the first data to be provided to the prompt executor among the plurality of data types, based on the table in which the accuracy is scored for each model; and
determine the type of the second data to be provided to the token generator, and
wherein the task comprises one of language translator, summarization, typo correction, or reply.

19. The recording medium of claim 17, wherein the processor is configured to:
in a case that a table corresponding to a task to be performed does not exist, identify resources of the electronic device;
based on remaining resources of the electronic device that exceed a predetermined level, measure the memory usage and the computational speed for each model when the plurality of models are provided based on the type of the first data and the second data;
determine a combination of data types having fastest computational speed among combinations of data types having memory usage relatively smaller than the remaining resources; and
perform inference and a task by using models composed by the determined combination.

20. The recording medium of claim 15, wherein the processor is configured to:
in case that a type of a task to be executed is determined and there are preconfigured conditions for the first data and the second data, determine the types of the first data and the second data, based on the preconfigured conditions;
provide the artificial intelligence model according to the determined data types and perform inference;
in a case that a type of a task to be executed is determined but there are no preconfigured conditions for the first data and the second data,
measure performance for each combination of data at least by performing inference through the artificial intelligence model while changing the types of the first data and the second data; and
provide the artificial intelligence model by a combination having relatively best performance, and
wherein the performance for each combination of data comprises at least one of a size of the memory, capability of a backend, key performance indicators (KPI), power consumption, or accuracy of inference.
